(19) United States
(12) Patent Application Publication
(10) Pub. No.: US 2019/0222691 A1
(43) Pub. Date: Jul. 18, 2019

(54) DATA DRIVEN ECHO CANCELLATION AND SUPPRESSION

(71) Applicant: Knowles Electronics, LLC, Itasca, IL (US)

(72) Inventors: Pratik Shah, Itasca, IL (US); Mathieu Parvaix, Itasca, IL (US); John Woodruff, Itasca, IL (US); Harsha Rao, Itasca, IL (US)

(73) Assignee: Knowles Electronics, LLC, Itasca, IL (US)

(21) Appl. No.: 16/250,124

(22) Filed: Jan. 17, 2019

Related U.S. Application Data
(60) Provisional application No. 62/618,873, filed on Jan. 18, 2018.

(51) Int. Cl. H04M 3/00

(52) U.S. Cl. CPC H04M 3/002

(57) ABSTRACT

The present embodiments are directed to removing echo from an audio signal using a two-stage process. The first stage aims at removing the linear portion of the echo signal that is representative of the acoustic propagation path between a loudspeaker and a microphone, for example. The second stage focuses on removing or suppressing any remaining or residual echo in the audio signal. The residual echo can include both residual linear echo and nonlinear contributions from the system, such as nonlinear echo produced by loudspeakers, amplifiers, microphones or even the body of the device itself. According to certain additional aspects, the echo cancellation and suppression techniques of the embodiments are built on a data-driven approach, where models are trained in both an offline and online process to assist in the detection and suppression of various forms of echo that can exist in a particular near-end environment.

### CROSS-REFERENCE TO RELATED APPLICATIONS

The present application claims priority to U.S. Provisional Patent Application No. 62/518873 filed Jan. 18, 2018, the contents of which are incorporated herein by reference in their entirety.

### TECHNICAL FIELD

The present embodiments relate generally to audio processing and more particularly to data driven echo cancellation and suppression.

### BACKGROUND

Many techniques for performing acoustic echo cancellation in audio communications systems are known, such as those described in U.S. Pat. Nos. 7,508,948, 8,259,926, 8,189,766, 8,355,511, 8,472,616, 8,615,392, 9,343,073, 9,007,416 and 9,438,992, as well as U.S. Patent Publ. Nos. 2016/0098921 and 2016/0150337, the contents of which are incorporated herein by reference in their entirety. However, opportunities for further improvement remain.

### BRIEF DESCRIPTION OF THE DRAWINGS

For a more complete understanding of the disclosure, reference should be made to the following detailed description and accompanying drawings wherein:

FIG. 1 comprises an environment in which the audio processing system disclosed herein may be used, according to an exemplary embodiment;

FIG. 2 comprises a block diagram of the audio processing system disclosed herein, according to an exemplary embodiment;

FIG. 3 illustrates a flow chart of an example method of training a neural network, according to an exemplary embodiment;

FIGS. 4A, 4B and 4C are time-frequency plots of example isolated and tagged audio signals that can be used in training a neural network according to embodiments; and

FIG. 5 illustrates a flow chart of an example method of performing data-driven acoustic echo cancellation and suppression, according to an exemplary embodiment;

FIG. 6 is a block diagram illustrating example training and filtering processes of a deep neural network of an audio processing system, according to an exemplary embodiment; and

FIG. 7 comprises a block diagram of an audio device including the audio processing system disclosed herein, according to an exemplary embodiment.

### DETAILED DESCRIPTION

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

According to certain aspects, the present applicant recognizes that the problem of removing echo from an audio signal can be approached as a two-stage process. The first stage aims to remove the linear portion of the echo signal that is representative of the acoustic propagation path between a loudspeaker and a microphone, for example. The second stage focuses on removing or suppressing any remaining or residual echo in the audio signal. The residual echo can include both residual linear echo and nonlinear contributions from the system, such as nonlinear echo produced by loudspeakers, amplifiers, microphones or even the body of the device itself. According to certain additional aspects, the echo cancellation and suppression techniques of the disclosed embodiments are built on a data-driven approach, where models are trained in both an offline and online process to assist in the detection and suppression of various forms of echo that can exist in a particular near-end environment.

### Acoustic Echo Cancellation

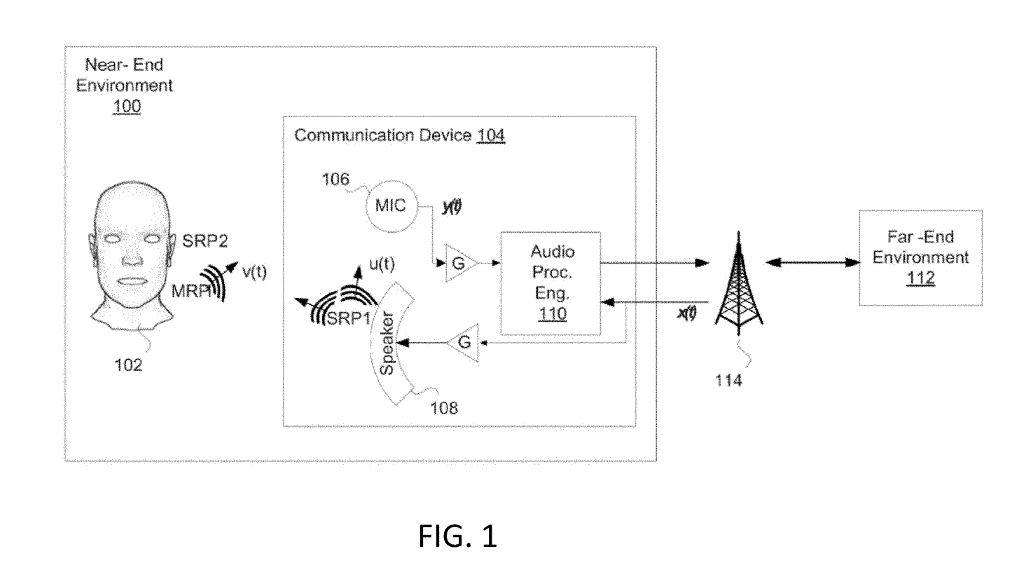

Referring now to FIG. 1, an environment 100 in which various embodiments disclosed herein may be practiced is shown. A user in a near-end environment 100 (e.g. a room, car, office, etc.) acts as an acoustic source 102 to a communication device 104 (e.g., a mobile phone, a mobile computing device, etc.).

The exemplary communication device 104 comprises a microphone 106 (i.e., primary microphone), speaker 108, and an audio processing system 110 including an acoustic echo cancellation and/or suppression mechanism according to embodiments. In some embodiments, an acoustic source 102 (e.g., the user) is near the microphone 106 which is configured to pick up audio from the acoustic source 102 (e.g., the user's speech). The audio received from the acoustic source 102 (e.g. a voice signal v(t)) will comprise a near-end microphone signal y(t), which will be sent back to a far-end environment 112.

An acoustic signal x(t), for example comprising speech from the far-end environment 112, may be received via a communication network 114 by the communication device 104. The received acoustic signal x(t) may then be provided to the near-end environment 100 via the speaker 108. The audio output from the speaker 108 may leak back into (e.g., be picked up by) the microphone 106 and into the signal y(t) in addition to voice signal v(t). This leakage may result in an echo perceived at the far-end environment 112.

The exemplary audio processing system 110 is configured to remove u(t) (which represents echoes of x(t)) from y(t), while preserving a near-end voice signal v(t). In some embodiments, the echoes u(t) include main echoes and residual echoes. The main echoes refer to acoustic signals that are output by the speaker 108 and then immediately picked up by the microphone 106. The residual echoes refer to acoustic signals that are output by the speaker 108, bounced (acoustically reflected) by objects in the near-end environment 100 (e.g., walls), and then picked up by the microphone 106.

In exemplary embodiments, the removal of u(t) is performed by audio processing system 110 without introducing distortion of v(t) to a far-end listener. This may be achieved by subtracting an estimate of the echo signal u(t) and/or calculating and applying time and frequency varying multiplicative gains or masks to the signal y(t) that render the acoustic echo inaudible or at least substantially reduced with respect to the voice signal v(t).

### Two-Stage Data Driven Echo Cancellation and Suppression

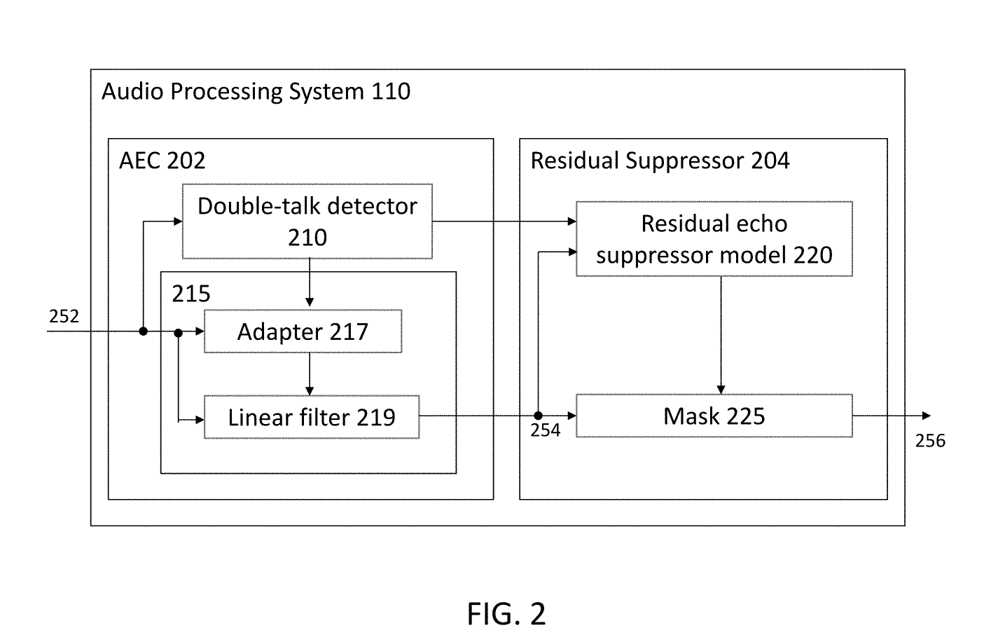

Referring now to FIG. 2, which comprises a block diagram of an exemplary audio processing system 110, according to embodiments.

The exemplary audio processing system 110 may perform acoustic echo cancellation (AEC) and/or suppression according to the present embodiments, among other things. As a result, an acoustic signal sent from the communication device 104 to the far-end environment 112 has been processed for reduced or eliminated echo from speaker leakage. In accordance with one embodiment, the audio processing system 110 performs removal of echo from a signal as a two-stage process. Accordingly, as shown, audio processing system 110 includes an AEC stage 202 and a residual echo suppressor stage 204. It should be noted that the system architecture of the audio processing system 110 of FIG. 2 is exemplary. Alternative embodiments may comprise more components, fewer components, or equivalent components and still be within the scope of embodiments of the present technology.

According to certain example aspects, a first AEC stage 202 of the audio processing system 110 removes a linear portion of the echo signal that is representative of an acoustic propagation path (e.g., the acoustic leakage path directly between speaker 108 and microphone 106). The second residual echo suppressor stage 204 removes a nonlinear portion of the echo signal, as well as any linear echo not removed in the first AEC stage 202. As set forth above, the nonlinear portion can be produced by various electronic components such as loudspeakers, amplifiers, microphones or even the body of the communication device itself.

An exemplary AEC stage 202 as shown in FIG. 2 includes a double-talk detector 210 and an adaptive filter 215. In general, “double talk” refers to a situation where both near-end (including, but not limited to, speech) and far-end signals are present. Some existing AEC technologies use an adaptive linear filter that adapts to the playback signal (i.e., the far-end signal x(t)). Among other things, the present applicant recognizes that if the adaptive filter adapts in the presence of near-end signals, the adaptive filter will mis-converge, often causing the adaptive filter to add echo instead of remove it. In one aspect of the present disclosure, the data driven double-talk detector 210 is used in the first stage to solve the problem of potential divergence of adaptive filter 215 when near-end signals are present. The ability to detect the presence of near-end signals in an accurate and timely manner improves the performance of the AEC stage 202 of the audio processing system 110. In some embodiments, double-talk detector 210 can include a model that is trained to detect double talk as will be described in more detail below. In other embodiments, a double-talk detector based on relative signal levels can be used to determine the presence of double-talk. For example, when the levels of both near-end and far-end signals exceed a threshold, double-talk can be said to be present.

As shown, adaptive filter 215 includes a linear filter 219 that is adapted to the echo signal (i.e., the far-end signal x(t)) by adapter 217. For example, linear filter 219 can have a transfer function that is controlled by variable parameters and adapter 217 can adjust those parameters according to an optimization algorithm. In one possible implementation, adapter 217 can use feedback in the form of an error signal to refine the parameters of the transfer function of linear filter 217 using a mean square value of the error signal. Many other alternatives are possible. In this particular system, linear filter 219 has been adapted to remove the echo signal from the input signal 252 to produce echo-reduced signal 254, and continuously operates to perform this function. Meanwhile, in embodiments shown in FIG. 2, when the double-talk detector 210 detects a presence of double-talk, the double-talk detector 210 freezes adapter functionality 217 of the adaptive filter 215. The freezing of the adaptation (but not the operation of linear filter 219) can be implemented, e.g., at frame level, frequency bin level or any other decomposition that is used for adaptation. Existing methods either require multiple frames of data to make the freezing decision or slow down adaptation to minimize impact of the divergence of the adaptive filter 215. At least one advantage of using a model-based double-talk detector 210 as described in more detail below is that the freezing decision is instantly available for the current frame and the adaptation can be stopped immediately for the current frame. It should be noted that linear filter 219 can be implemented using many known AEC techniques, and so further details thereof will be omitted here for sake of clarity of the present embodiments.

At the second residual echo suppressor stage 204, one or more data driven masks 225 generated by the residual echo suppressor model 220 can be used to suppress the nonlinear residual echo that remains in the echo-reduced signal 254. In some embodiments, the residual echo suppressor model 220 can generate the data driven masks 225 for each time and frequency bin and then the masks 225 are applied to the echo-reduced signal 254 to suppress the residual echo in the final output signal 256. Such a data-driven approach leverages the information contained in the multiple cues that are used to train the residual echo suppressor model 220 as described in more detail below to allow for improved echo suppression even at low signal-to-echo ratios (SERs). SER is similar in concept to SNR, signal to noise ratio. A negative SER (in decibels) means the echo signal has a higher level than the speech signal. This is a challenging echo suppression case, but it is common in some scenarios such as an IoT use case where the talker is usually multiple meters away from the microphone while the loudspeaker is a few centimeters from the microphone. Cases of very low SER (e.g., between −10 to −20 dB) in these scenarios are common.

In some embodiments, both, or either of, the model of double-talk detector 210 and the residual echo suppressor model 220 can be trained offline using a database of audio materials as will be described in more detail below. While the variety of the training data ensures that the trained models generalize well to a multitude of acoustic scenes and devices, performance can be enhanced if the specifics of the acoustic scene and device can be learned by the model(s). Regarding the second stage of nonlinear portion removal in particular, the present applicant recognizes that nonlinear components present in a signal largely depend on the components used for collecting, transmitting and/or playing back acoustic signals (and also their wear and tear). Thus, tracking the changes in the nonlinear characteristics of the components and knowledge of the specifics of the acoustic scene around the device help in improving the quality of echo cancellation.

In some embodiments, also to be described in more detail below, in order to better track the changes in device characteristics, an online training approach can be used to further refine models that are trained offline. The online training approach includes capturing live data on the device (e.g., when near-end sound is minimal), using this data to create synthetic acoustic mixtures for training, and training new models that can be tailored to the specific characteristics of the device and the acoustic scene the device is in. In other words, the enhancement of the model(s) can be done by capturing live data from the device, and using this live data to train and update the models (leveraging the more generic models as a starting point). This allows performance improvements in-situ after the device has been actively used. The benefit of this approach is that solutions can be deployed with a large but limited set of training data and specific tuning for a device may occur automatically during use.

Along these lines, returning to FIG. 2, double talk detector 210 shown in this example can generate a signal to residual suppressor 204 indicating when there is no double-talk (e.g., when near-end sound is minimal), and this signal can be used to indicate when online training can be performed.

### Data Driven Models for Echo Cancellation

In some embodiments, both, or each of, the double-talk detector 210 and the residual echo suppressor model 220 can be implemented as (or include) one or more neural network models. In some embodiments, a neural network model can be trained and used for both the double-talk detector model 210 and the residual echo suppressor model 220. In some alternative embodiments, separate neural network models can be trained and used respectively for the double-talk detector model 210 and the residue echo suppressor model 220.

According to some embodiments of the present disclosure to be described in more detail below, the present embodiments utilize deep learning to remove residual linear and non-linear echo from an input signal. Deep learning refers to a learning architecture that uses one or more deep neural networks (NNs), each of which contains more than one hidden layer. The deep neural networks may be, e.g., feed-forward neural networks, recurrent neural networks, convolutional neural networks, etc. In some embodiments, data driven models or supervised machine learning models other than neural networks may be used as well. For example, a Gaussian mixture model, hidden Markov model, or support vector machine may be used in some embodiments.

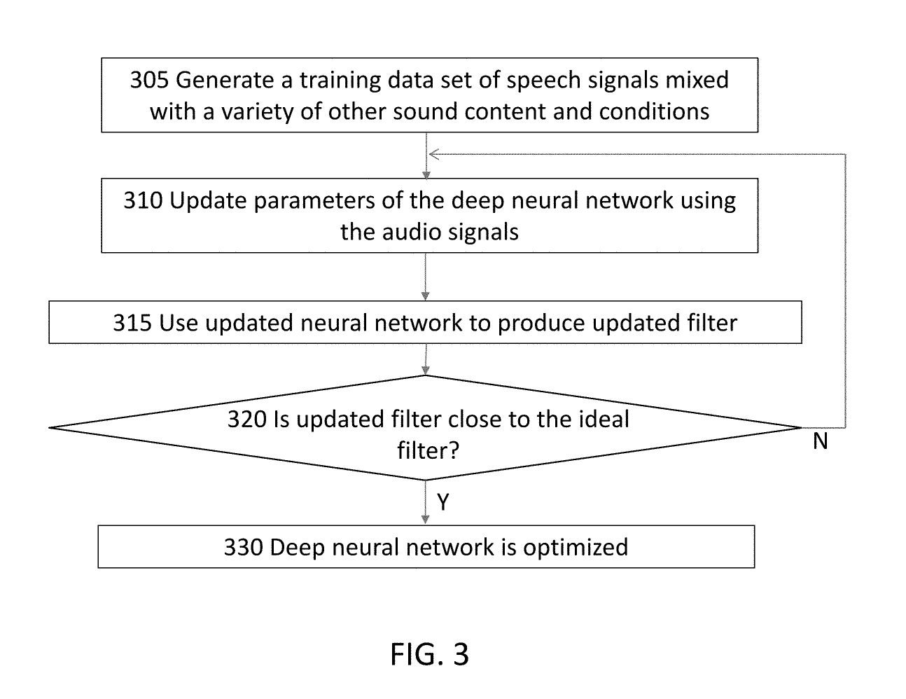

FIG. 3 is a flowchart further illustrating an example method of training a deep neural network according to some embodiments of the present disclosure. The following descriptions will focus on an example embodiment of training a deep neural network for residual echo suppressor model 220, in which speech is the only target signal. However, for either or both of double talk detector 210 and residual echo suppressor model 220, a source classifier approach such as that described in U.S. Provisional Application No. 62/611,218, the contents of which are incorporated by reference herein, could be used to train the deep neural networks.

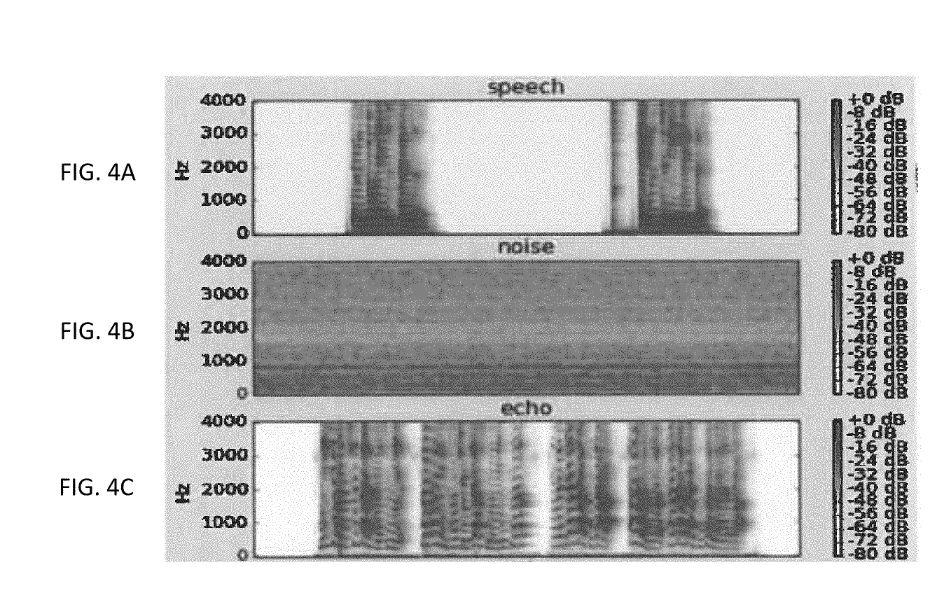

The training process starts in step 305 by generating a training data set including audio signals containing speech mixed with a variety of other sound content. For example, sound content could be drawn from a large audio database. Audio content in this database is preferably captured with one (mono) or two (stereo) high-quality microphones at close range in a controlled recording environment. The audio signals in this database are preferably tagged with known content categories or descriptive attributes. Time-frequency plots of example isolated and tagged audio signals for speech, noise and echo that can be used in a training methodology such as the methodology of the present embodiments are shown in FIGS. 4A, 4B and 4C, respectively.

Each audio content signal drawn from the database is convolved with a multi-microphone room impulse response (RIR) that characterizes acoustic propagation from a sound source position to the device microphones. This forms the near-end signal. Similarly, sound content characteristic of what would be played from a loudspeaker, such as music, speech, white noise, etc., is required as the far-end signal. This can be achieved in one of two ways. A first method may use a selected signal drawn from an audio database and convolved with a loudspeaker-echo path-microphone impulse response to obtain the echo signal at the microphone. This first method requires modeling of loudspeaker and microphone nonlinearities and an impulse response of the acoustic path between the loudspeaker and the microphone. Alternately, the selected signal drawn from the database may be played out of the device and recorded at the microphone in absence of any near-end signals. It is preferable that while mixing near-end and far-end signals, impulse responses for the same room are used. Training datasets may be created with a mismatch in impulse response for the far-end and near-end signal but may suffer from performance issues. The first method allows producing large amounts of training data without any real-time constraints. The latter results in a more accurate depiction of device characteristics. In order for the pre-trained model to generalize to unseen acoustic data, it is preferable to generate a multitude of audio mixtures with many instances of sound events. Further, it is desirable to use RIRs for many sound source positions, device positions and acoustic environments and to mix content at different sound levels. In some embodiments, this process may result in tens, hundreds or even thousands of hours of audio data.

In step 310, a model coefficient update process is performed to update parameters of the deep neural network until the deep neural network is optimized. As shown in this example, the update process can be performed iteratively from random coefficient initialization and in step 315 the updated deep neural network is used to produce an updated filter. For example, and as will be described in more detail below, the training data containing speech signals mixed with a variety of other sound content can be fed to a feature extraction module to generate signal features in the frequency domain. The deep neural network that is being trained receives the signal features and generates a frequency mask that filters the audio signals to generate an echo suppressed speech signal.

In step 320 the frequency mask or filter that is generated by the deep neural network is compared to the optimal frequency mask, or “label”. The optimal frequency mask is available in training because audio mixtures are created from mixing the clean content signals, making it possible to compute the frequency mask that perfectly reconstructs the magnitude spectrum of the target speech signal in a process called label extraction. As shown, the model coefficient update process in step 310 can be repeated iteratively, for example using a gradient descent approach, until the frequency mask produced by the deep neural network is very close to the optimal mask, at which point the deep neural network is optimized. In some embodiments, the magnitude spectra or complex spectra of the separated target signal (i.e. speech) can be estimated directly by the deep neural network. In this case, the spectra produced by the deep neural network can be compared to the clean signal spectra during optimization.

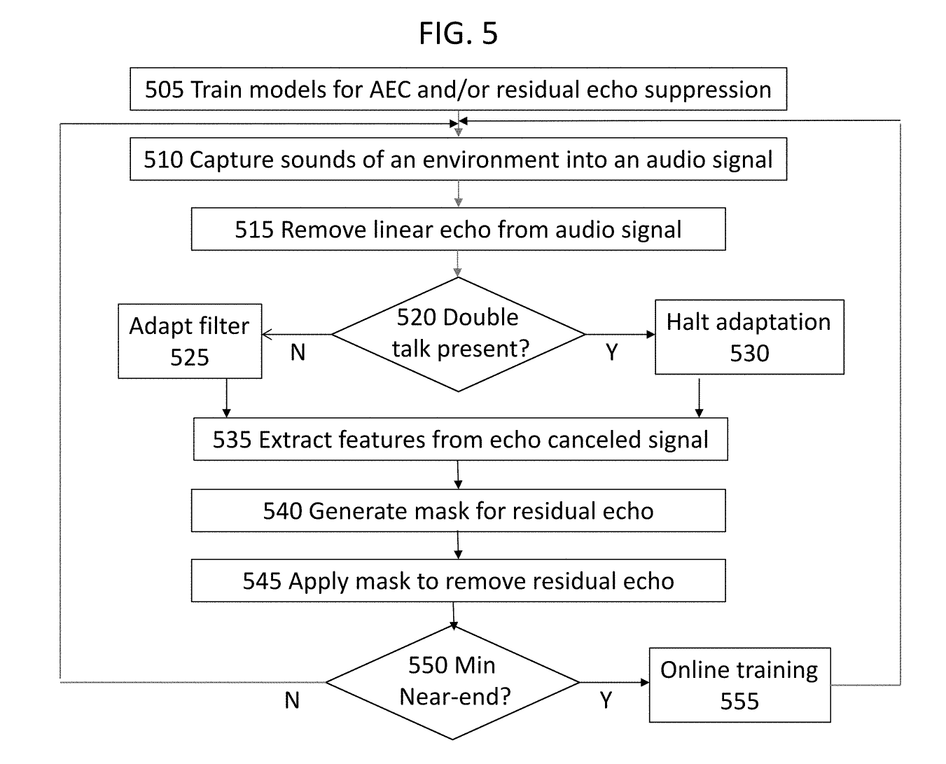

FIG. 5 illustrates a flow chart of an example method of performing data-driven audio echo cancellation and suppression according to the present embodiments.

At step 505, an offline training process is performed for models used in AEC stage 202 and/or residual echo suppressor stage 204, such as the training described above in connection with FIG. 3.

In step 510, one or more microphones capture sounds of an environment into an audio signal. The audio signal can include a combination of near-end sounds and possibly linear and non-linear echo of far-end sound played back in the near-end environment. In some embodiments, the one or more microphones are part of the audio processing system. In some other embodiments, the one or more microphones are external components or devices separate from the audio processing system. In some embodiments, at least one time-domain audio signal captured from one or more microphones is transformed into a frequency domain or a time-frequency domain (using, e.g., fast Fourier transform (FFT), short-time Fourier transform (STFT), and/or an auditory filterbank). In these and other embodiments, the captured audio signal is a frame-based audio signal.

At step 515, acoustic echo cancellation is performed to remove as much linear echo as possible in the captured audio signal. A linear filter such as linear filter 219 is used to remove the linear echo, which as described above can be implemented using one of any known AEC linear filters.

At step 520, it is determined whether double talk is present. As set forth above, in some embodiments, double-talk detector 210 can include a model that is trained to detect double talk as described in more detail above in connection with FIG. 3. In other embodiments, a threshold detector based on heuristics can be used to determine when the level of both near-end and far-end signals exceed an amount where both are considered active at the same time.

If no double talk is present, the linear filter 219 is adapted in step 525. Otherwise, the adaptation 517 of the adaptive linear filter 215 is halted in step 530.

In either event, the signal after processing by acoustic echo cancellation is provided to the residual echo suppressor stage 204 and in step 535, feature extraction is performed on the frequency domain representation of the linear echo removed audio signal. Examples of features that can be extracted from the audio signal, as well as examples of how feature extraction can be done, are described in more detail below.

Next in step 540, the audio signal after processing by acoustic echo cancellation and extracted features are used as inputs to at least one deep neural network. The neural network may run in real time as the audio signal is captured and received. The neural network receives a new set of features for each new time frame and generates a new time-varying filter (i.e. time-frequency mask 225) for that time frame corresponding to the residual echo in the near-end environment. In some embodiments, the time-varying filter is a time-varying real-value function of frequency. A value of the real-value function for a corresponding frequency represents a level of attenuation for the corresponding frequency.

At step 545, the residual suppressor 204 removes residual echo by applying the time-varying filter (i.e. mask 225) to the audio signal. More particularly, the time-frequency mask is a real-valued function (also referred to as masking function) of frequency for each time frame, where each frequency bin has a value between 0 and 1. The masking function is multiplied by a complex, frequency-domain representation of the audio signal to attenuate a portion of the audio signal at those time-frequency points where the value of the masking function is less than 1. For example, a value of zero of the masking function mutes a portion of the audio signal at a corresponding time-frequency point. In other words, sound in any time-frequency points where the masking function is equal to 0 is inaudible in a reconstructed output signal filtered by the masking function.

Accordingly, mask 225 generated by the neural network for the residual echo suppressor model 210 can separate the residual echo from the linear-echo-removed audio signal and thereby remove it from the audio signal to thereby output a representation of a linear echo removed and residual and non-linear echo suppressed audio signal for the current time frame.

At step 550, it is determined whether near-end sound is suitable for performing a model update. If so, in step 555, online training of the model(s) is performed as will be described in more detail below. In either event, processing can return to step 510 to resume processing for a new time frame.

More particularly in connection with step 555, it should be noted that the training process performed as illustrated in the example method described in connection with FIG. 3 is an offline process. Offline training of the deep neural network must be performed for an initial configuration. However, in some embodiments, the deep neural network coefficients can be updated online to further optimize performance for the acoustics and environment of a given device. In this case the network is able to complement the initial training data with new data collected live on the device. Because updating the neural network coefficients requires definition of the optimal frequency mask, any newly collected data live on device must largely contain far-end echo and have minimal near-end content as determined in step 550. Model coefficients could then be updated and then downloaded to update the coefficients being used by the online system. In some embodiments, this process would not be expected to occur in real-time and training may not be performed directly on device. However, this approach enables the networks to refine themselves over a period of minutes, hours or even days through occasional model updates.

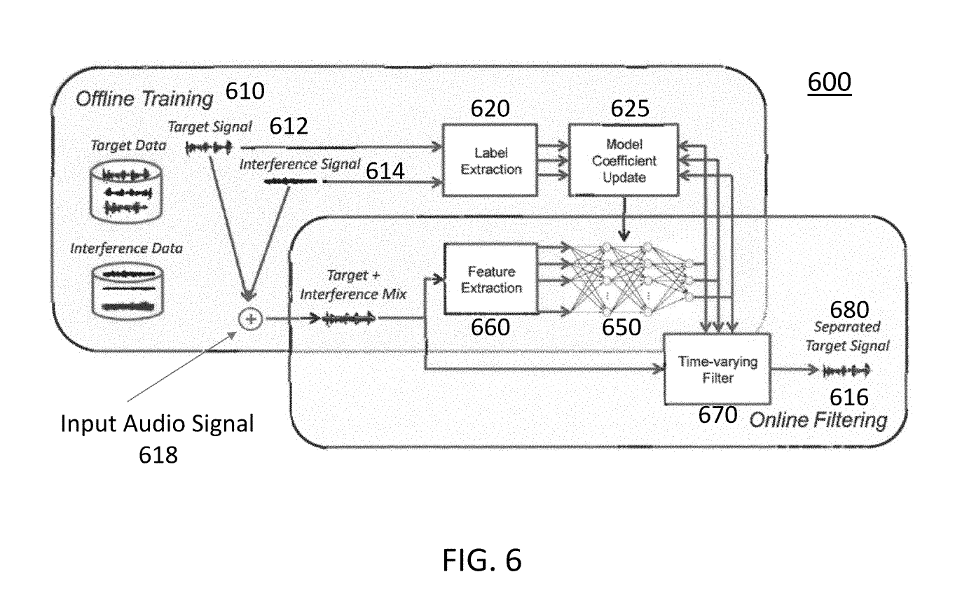

For example, FIG. 6 is a block diagram illustrating one possible way of combining offline training and online filtering processes of a deep neural network of an acoustic echo cancellation and suppression system, according to some embodiments of the present disclosure. In such embodiments, an offline training stage 610 is used to train the deep neural network 650 as described above. More particularly, the offline training stage 610 involves iteratively feeding a training data set to the deep neural network 650. For example, the training data set may be various combinations of a target signal 612 of speech and one or more interference signals 614 of another known sound content category (e.g., echo).

As set forth above, the combination of the target signal 612 and the interference (far-end echo) signal 614 is used to perform a label extraction 620 to obtain an optimal filter that can reproduce the target signal 612 from the combination. More particularly, because the “clean” version of the target signal 612 is known, it is very straightforward to compute the optimal filter that can be applied to the combination of the target signal 612 and the interference (far-end echo) signal 614 so as to obtain the target signal 612. This computation is performed by label extraction 620. Also during offline training, a model coefficient update process 625 is performed using features extracted from the combination of the target signal 612 and interference (far-end echo) signal 614 to update parameters of the deep neural network 650. As shown in FIG. 6, the training data including the combination of the target signal 612 and the interference (far-end echo) signal 614 is fed to the feature extraction module 660, whose output is provided to the deep neural network 650, which outputs a time-varying filter. Model coefficient update process 625 compares the time-varying filter output by deep neural network 650 with the optimal filter from label extraction 620 and updates the model coefficients of deep neural network 650 based on the comparison. This process of feeding the feature extraction module 660 with training data and generating updated time-varying filters is performed iteratively until the deep neural network 650 is optimized. In other words, the optimized deep neural network 650 can generate a filter 670 (i.e. mask) that can be used to produce an output signal that is the same as, or close to, the target signal 612.

Once the deep neural network 650 is trained, the deep neural network 650 may be provided for use in an online filtering stage 616. An audio input 618 containing speech and echo (combination of linear and nonlinear echo) can be fed to a feature extraction module 660 to generate signal features in the frequency domain (the same signal features that are extracted during off-line training). The deep neural network 650 (trained during the offline process described above) receives the signal features and generates a time-varying filter 670 (i.e. mask 225). The frequency mask 670 filters the audio signals to generate a separated target audio signal 680 (e.g., an audio signal of a target sound content category such as speech).

In embodiments such as that shown in FIG. 6, the feature extraction module 660 extracts signal features in the frequency domain representation of signal 618. The signal features can be extracted from the audio signal in various ways known to those skilled in the art, depending upon the type of signal feature that is extracted. For example, where the audio signal comprises sounds captured by several different microphones, the signal features can include phase differences between sound signals captured by the different microphones, magnitude differences between sound signals captured by the different microphones, respective microphone energies, etc. For individual sound signals from a given microphone, the signal features may include magnitude across a particular spectrum, modulations across a spectrum, frames of magnitude spectra, etc. In these and other embodiments, the signal features may include information representing relationships or correlations between the audio signals and/or between audio signals from different microphones such as inter-microphone coherence. In some embodiments, the signal features may be represented by, e.g., vectors. In additional or alternative embodiments, some or all of signal features can also be captured from the time-domain signals.

As set forth above, after off-line training and during the online filtering process 616, the filtering results can be fed back into the process 610 and added to the training data that is used to train the deep neural network 650. For example, time segments of live audio 618 that are suitable for “online” training the deep neural network 650 to obtain the target signal (i.e. speech) can be identified in various ways, and these time segments can be used to refine the model coefficients so as to more closely align the deep neural network 650 for the particular online device and/or environment.

In a cloud based or similar embodiments, these captured time segments of live audio data can then be uploaded back to the offline model training 610 process and added to the content used during offline model training 610. Model coefficients could then be updated in stage 625 of offline training process 610 and then the updated deep neural network 650 can be downloaded back to the online filtering stage 616 to update the coefficients being used by the network 650 of the online system 616. In other embodiments, the deep neural network 650 can be incrementally updated online on the device itself using the captured time segments of live audio data.

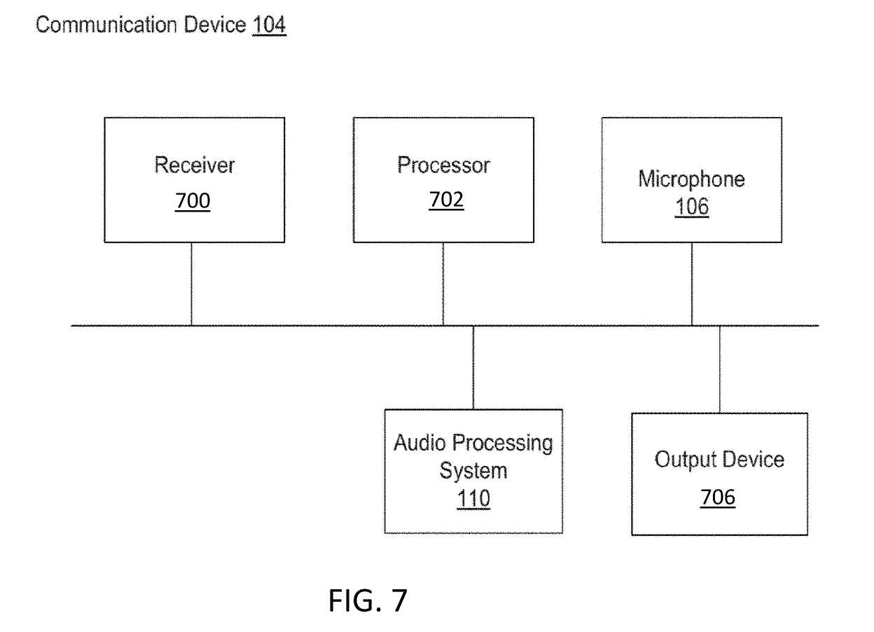

Referring now to FIG. 7, an exemplary communication device 104 is shown in further detail. In exemplary embodiments, the communication device 104 comprises a receiver 700, a processor 702, the microphone 106, the audio processing system 110, and an output device 706. The communication device 104 may comprise more or other components necessary for operations of the communication device 104. Similarly, the communication device 104 may comprise fewer components that perform similar or equivalent functions to the components illustrated in FIG. 7.

The exemplary receiver 700 (e.g., a networking component) is configured to receive the far-end signal x(t) from the network 114. The receiver 700 may be a wireless receiver or a wired receiver. In some embodiments, the receiver 700 may comprise an antenna device. The received far-end signal x(t) may then be forwarded to the audio processing system 110 and the output device 706.

The audio processing engine 110 can receive the acoustic signals from the acoustic source 102 via the microphone 106 (e.g., an acoustic sensor) and process the acoustic signals. After reception by the microphone 106, the acoustic signals may be converted into electric signals. The electric signals may be converted by, e.g., an analog-to-digital converter (not shown) into digital signals for processing in accordance with some embodiments. It should be noted that embodiments of the present technology may be practiced utilizing any number and type of microphones.

In embodiments, audio processing system 110 is embodied as hardware (e.g. one or more processors) and software for performing the acoustic echo cancellation methodologies described herein, perhaps along with other processing. In some embodiments, although shown separately for ease of illustration, the audio processing system 110 can be embodied as software that is stored on memory or other electronic storage and executed by processor 702. In other embodiments, the audio processing system 110 can be embodied as software and can be executed by one or more processors, which may not include the processor 702. For example, the microphone 106 may include one or more processors that can execute some or all of the software of the audio processing engine 110. In some other embodiments, the audio processing system 110 can be embodied as software and can be executed partially by the processor 702, and partially by one or more additional processors separate from the processor 702. One or more of the processor 702 and the other processor(s) may be implemented as, or at least include, a digital signal processor (DSP) or an application-specific integrated circuit (ASIC).

Output device 706 provides an audio output to a listener (e.g., the acoustic source 102). For example, output device 706 may comprise speaker 108, an earpiece of a headset, or handset of the communication device 104.

As used herein, the singular terms “a,” “an,” and “the” may include plural referents unless the context clearly dictates otherwise. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances.

There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method, comprising:
receiving an audio signal;
first processing the audio signal to reduce a linear portion of acoustic echo from the audio signal;
second processing the audio signal after the first processing, the second processing being performed to reduce a residual portion of acoustic echo from the audio signal wherein the second processing includes applying a mask to the audio signal after the first processing, the mask being generated based on the audio signal after the first processing using a first model that has been trained to generate masks for suppressing residual echo from audio signals containing speech.

2. The method of claim 1, wherein the first model has been trained in one or both of an offline and an online training process.

3. The method of claim 1, wherein the first model comprises a neural network.

4. The method of claim 1, wherein the first processing includes applying a linear filter to the audio signal, wherein the linear filter has been adapted to an echo signal.

5. The method of claim 4, further comprising:
detecting the presence of double talk in the audio signal; and
halting or slowing adaptation of the linear filter when double talk has been detected.

6. The method of claim 5, wherein the detecting is performed using a second model that has been trained to detect double talk.

7. The method of claim 6, wherein the second model comprises a neural network.

8. The method of claim 1, wherein mask comprises a time-varying real-valued function of frequency, wherein a value of the time-varying real-valued function for a corresponding frequency represents a level of signal attenuation to apply to the audio signal.

9. The method of claim 8, wherein the audio signal comprises a plurality of frames, and wherein the mask is generated for each of the plurality of frames.

10. The method of claim 1, further comprising extracting a plurality of features from the audio signal, wherein generating the mask is further based on the extracted features.

11. The method of claim 10, wherein the plurality of features include one or more of spectral magnitude information associated with the audio signal, spectral modulation information associated with the audio signal, phase differences between sound signals captured by a plurality of different microphones, magnitude differences between sound signals captured by the plurality of different microphones, and respective microphone energies associated with the plurality of different microphones with respect to the audio signal.

12. A system for processing an audio signal, comprising:
an acoustic echo canceller including a linear filter configured to reduce a linear portion of acoustic echo from the audio signal; and
a residual echo suppressor including:
a mask configured to reduce a residual portion of acoustic echo from the audio signal after it has been processed by the first processing stage, and
a first model configured to generate the mask based on the audio signal, wherein the first model has been trained to generate masks for suppressing residual echo from audio signals containing speech.

13. The system of claim 12, wherein the first model has been trained in one or both of an offline and an online training process.

14. The system of claim 13, wherein the first model comprises a neural network.

15. The system of claim 12, wherein the acoustic echo canceller further includes an adapter that adapts the linear filter to an echo signal.

16. The system of claim 15, wherein the acoustic echo canceller further includes a detector configured to detect the presence of double talk in the audio signal and to halt or slow the operation of the adapter when double talk has been detected.

17. The system of claim 16, wherein the detector includes a second model that has been trained to detect double talk.

18. The system of claim 17, wherein the second model comprises a neural network.

19. The system of claim 12, wherein the mask comprises a time-varying real-value function of frequency, wherein a value of the time-varying real-value function for a corresponding frequency represents a level of signal attenuation to apply to the audio signal.

20. The system of claim 19, wherein the audio signal comprises a plurality of frames, and wherein the mask is generated for each of the plurality of frames.
